(19) United States
(12) Patent Application Publication
(10) Pub. No.: US 2015/0342230 A1
(43) Pub. Date: Dec. 3, 2015

(54) Popcorn Popper

(71) Applicant: Charles J. Hymore, Oregon, OH (US)

(72) Inventor: Charles J. Hymore, Oregon, OH (US)

(21) Appl. No.: 14/289,885

(22) Filed: May 29, 2014

(51) Int. Cl. A23L 1/18

(52) U.S. Cl. CPC A23L 1/1815; A23L 1/1812; A23V 2002/00

(57) ABSTRACT

A method of popping popcorn includes placing unpopped popcorn kernels and cooking oil in a pan configured to contain popcorn kernels to be popped and placing the pan on a source of heat. The pan is heated until the popcorn kernels reach a popping temperature and begin to pop. The pan is then removed from the source of heat and at least a portion of the cooking oil is poured from the pan through a drain port formed in the pan. The drain port is configured for the transmission of fluid between an inside of the pan and an outside of the pan.

### BACKGROUND OF THE INVENTION

Various embodiments of a cooking apparatus are described herein. In particular, the embodiments described herein relate to an improved cooking apparatus for cooking popcorn.

Many apparatus or methods of popping popcorn are known, including hot-air poppers, stovetop popcorn poppers, commercial popcorn popping machines, and heating pre-packaged servings of popcorn in a microwave oven. Known stovetop popcorn poppers typically include a pot or pan having substantially flat bottom and an upright cylindrical side wall extending upwardly from the periphery of the bottom. The pan is configured to be heated on burners of gas or electric stoves. The interior of the pan is configured for containing popcorn.

To facilitate heating of the popcorn kernels, oil, such as vegetable oil is placed in bottom of the pan with un-popped popcorn kernels. Butter and other flavoring may be added to the popcorn and oil as well. The oil provides even heating, uniform popping of the popcorn kernels, and minimizes the occurrence of burned and un-popped popcorn kernels. The benefits provided by the use of oil are achieved when the popcorn kernels reach a popping temperature, defined as the temperature at which the popcorn kernels begin to pop.

Upon reaching the popping temperature, the popcorn kernels pop. During the popcorn popping process, the popped kernels absorb the oil, butter, or other fluids in the popcorn popper, and may cause the popped corn to be undesirably wet. In addition to being undesirably wet, the oil, butter, or other fluids on the popcorn adds extra calories to the popped corn. Accordingly, there is a need for an improved popcorn popper.

### SUMMARY OF THE INVENTION

The present application describes various embodiments of a popcorn popper and methods of popping popcorn. One embodiment of the method of popping popcorn includes combining unpopped popcorn kernels and cooking oil in a pan configured to contain popcorn kernels to be popped; heating the pan with a source of heat until the popcorn kernels reach a popping temperature and begin to pop; and pouring at least a portion of the cooking oil from the pan through a drain port formed in the pan, the drain port configured for the transmission of fluid between an inside of the pan and an outside of the pan.

Another embodiment of the method of popping popcorn includes combining unpopped popcorn kernels and cooking oil in a pan mounted within a commercial popcorn popping machine case and configured to contain popcorn kernels to be popped; heating the pan with a source of heat until the popcorn kernels reach a popping temperature and begin to pop; and pouring at least a portion of the cooking oil from the pan through a drain port formed in a wall of the pan, the drain port configured for the transmission of fluid between an inside of the pan and an outside of the pan.

In another embodiment, a popcorn popper includes a pan configured to contain popcorn kernels to be popped, and a drain port formed in a wall of the pan, the drain port configured for the transmission of fluid between an inside of the pan and an outside of the pan.

Other advantages of the cooking apparatus will become apparent to those skilled in the art from the following detailed description, when read in view of the accompanying drawings.

### BRIEF DESCRIPTION OF THE DRAWINGS

FIG. 1 is a perspective view of a first embodiment of a popcorn popper according to the invention.

FIG. 2 is a perspective view of a portion of an inside surface of the popcorn popper illustrated in FIG. 1.

FIG. 3 is a perspective view of a portion of the popcorn popper illustrated in FIG. 1, showing the drain assembly.

FIG. 4 is a top plan view of the drain assembly illustrated in FIGS. 1 and 3, showing the drain closure in a closed position.

FIG. 5 is a top plan view of the drain assembly illustrated in FIGS. 1 and 3, showing the drain closure in an opened position.

FIG. 6 is a perspective view of a second embodiment of a popcorn popper according to the invention.

FIG. 7 is a perspective view of a first embodiment of a container for collecting fluid from a popcorn popper according to the invention.

FIG. 8 is a perspective view of a second embodiment of a container for collecting fluid from a popcorn popper according to the invention.

FIG. 9 is a side elevational view of a third embodiment of a container for collecting fluid from a popcorn popper according to the invention.

FIG. 10 is a top plan view of a portion of a pan of the popcorn popper illustrated in FIGS. 1 and 2, showing a second embodiment of the drain port.

FIG. 11 is a top plan view of a portion of a pan of the popcorn popper illustrated in FIGS. 1 and 2, showing a third embodiment of the drain port.

FIG. 12 is a top plan view of a portion of a pan of the popcorn popper illustrated in FIGS. 1 and 2, showing a fourth embodiment of the drain port.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

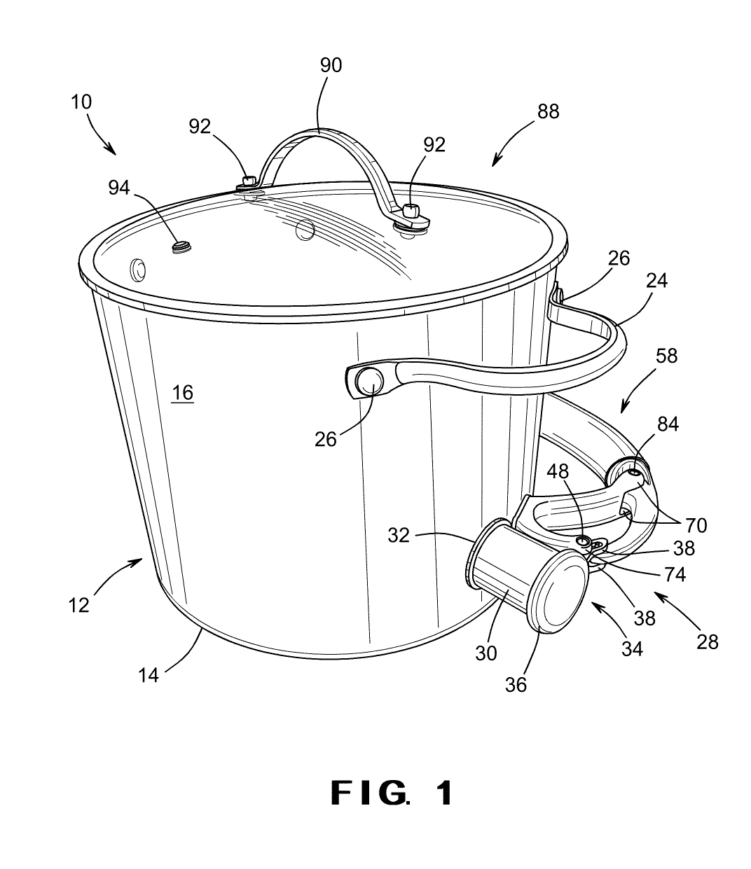

Referring now to FIG. 1, a first embodiment of a cooking apparatus is shown at 10. The exemplary cooking apparatus shown in FIG. 1 is a popcorn popper, however it will be understood that the invention described herein may be used with any desired cooking apparatus.

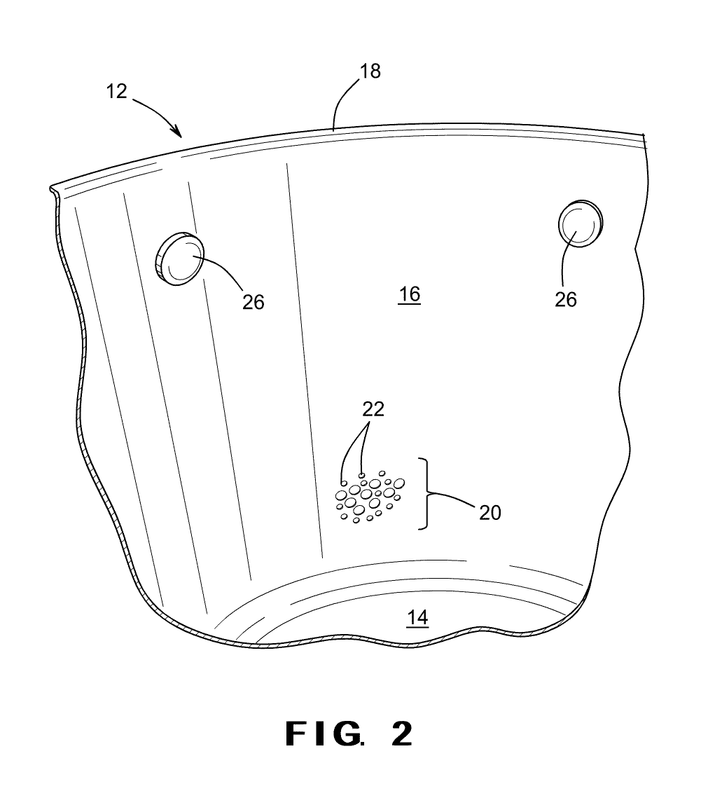

The illustrated popcorn popper 10 includes a pot or pan 12 having a circular bottom wall 14 and an annular sidewall 16 attached to the bottom wall 14 and defining a circular pan opening 18, best shown in FIG. 2. The sidewall 16 of the pan 12 includes a first embodiment of a drain port 20, also best shown in FIG. 2. The illustrated drain port 20 comprises a plurality of holes 22 formed through the sidewall 16. Any number of holes 22, suitable for the flow of fluid from inside the pan 12 to outside the pan 12, may be formed in the sidewall 16. The holes 22 may be of any desired size. In the illustrated embodiment, the holes 22 are large enough to allow fluid, such as cooking oil to flow through, and small enough to prevent a typical popped or unpopped kernel of corn from passing through.

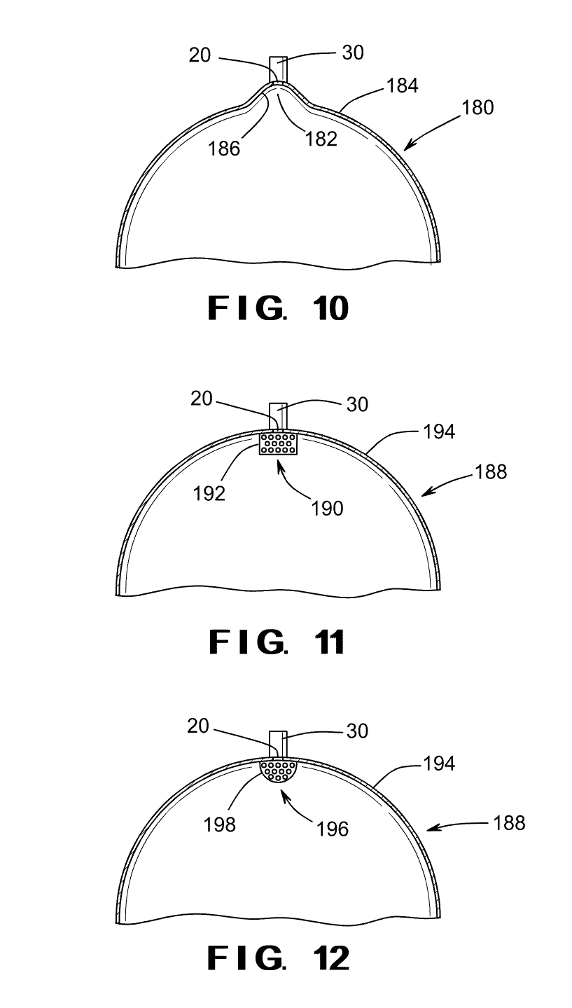

FIG. 10 illustrates a pan 180 having second embodiment of the drain port 182. The drain port 182 includes a recess 186 formed in a sidewall 184 of the pan 180. The hole or holes 22 are formed in the recess 186. If desired, the drain port 182 may include the drain tube 30. The recess 186 facilitates draining of fluid from the inside the pan 180, as described in detail below, by providing a basin within which fluid may collect as the pan 180 is tipped, channeling fluid through the drain port 182.

FIG. 11 illustrates a pan 188 having a third embodiment of the drain port 190. The drain port 190 includes a screen 192 attached by any desired means to an inside surface of a sidewall 194 of the pan 188. The screen 192 may be formed of any desired material having openings or holes large enough to allow fluid to flow through, and small enough to prevent a typical popped or unpopped kernel of corn from passing through. In the illustrated embodiment, the screen is three dimensional and extends into the interior of the pan 188. This configuration allows for popped or unpopped popcorn kernels to accumulate against the screen 192, while preventing the drain port 190 from becoming blocked. The screen may have any desired shape, such as for example, a rectangular prism or a cylinder.

FIG. 12 shows the pan 188 having a fourth embodiment of the drain port 196. The drain port 196 includes a screen 198 attached to the inside surface of the sidewall 194. The illustrated screen 198 has semi-spherical shape and functions in the same manner as the screen 192 described above. If desired, a screen such as the screens 192 and 198, may be attached within the recess 184 shown in FIG. 10.

The pan 12 may be formed having any desired height and any desired diameter. The pan 12 may be formed from any desired material. Non-exclusive examples of suitable material include aluminum and stainless steel.

A handle 24 may be attached to the pan 12 by fasteners 26. The fasteners 26 may be any desired type of fastener suitable for attaching the handle 24 to the pan 12. Non-exclusive examples of suitable fasteners include threaded fasteners and rivets. The handle 24 may also be attached to the pan 12 by welding or with adhesive. Although only one handle 24 is illustrated, the popcorn popper 10 may include two or more handles 24. The popcorn popper 10 may also be provided with a handle that is removably mounted to the pan 12, or may have no handle.

A drain assembly 28 is attached to a lower portion of the pan 12 near the bottom wall 14. The illustrated drain assembly 28 includes the drain tube 30 positioned about the drain port 20 and attached to the sidewall 16. The illustrated drain tube 30 is cylindrical and attached to the sidewall 16 via a collar 32. The collar 32 and the drain tube 30 may be attached to the sidewall 16 by any desired means, such as for example by welding, with adhesive, by press fit, or by threaded attachment. Alternatively, the drain tube 30 may be integrally formed with the pan 12.

Alternatively, the drain tube 30 may have any other shape suitable for the discharge of fluid from within the pan 12. In the illustrated embodiment, the drain tube 30 is positioned slightly above the bottom wall 14. The drain tube 30 may also be positioned at any desired location on the sidewall 16 in order to facilitate the discharge of fluid from within the pan 12.

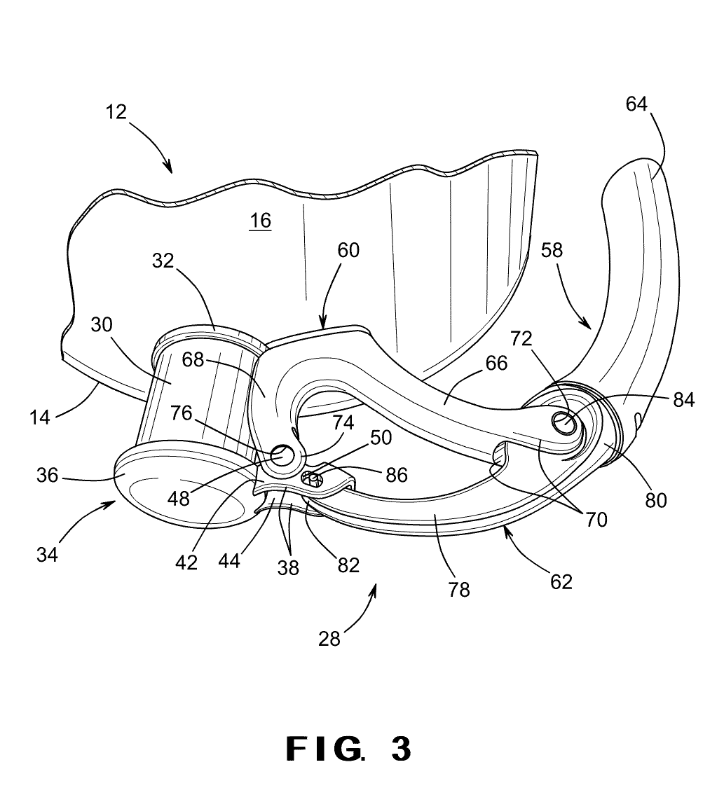

The drain assembly 28 includes a closure 34 having a circular closure portion or cap 36 and an attachment member 38 extending outward of the cap 36. A first portion of the attachment member 38 defines a cam 40. As best shown in FIGS. 1 and 3, the illustrated embodiment of the drain assembly 28 includes two attachment members 38 extending outward of the cap 36, parallel to each other and connected at their distal ends. Alternatively, the attachment members 38 may not be connected at their distal ends as shown. Each of the parallel attachment members 38 has an outboard side 42 and an inboard side 44. Cylindrical posts 48 extend outwardly from the outboard sides 42 of the first portion of the attachment members 38. Elongated slots 50 are also formed in the attachment members 38. The purposes of both the posts 48 and the slots 50 will be described below.

Alternatively, other types of closures may be used. Non-limiting examples of other types of closures include a threaded closure, a plug or stopper, a simple flip lid, and a plunger-type lid. The closures may be made from the same material as the pan 12, such as aluminum or stainless steel, silicone rubber, which is not negatively affected by heat, or other heat-resistant materials. Additionally, the drain tube 30 may have no closure.

A closure actuator or handle assembly 58 includes a spring 52, a first handle portion or base 60, a second handle portion 62, and a third handle portion or grip 64.

The illustrated spring 52 is substantially L-shaped and includes a substantially flat first leg 54 and a substantially flat second leg 56. The first leg 54 in attached to an outside surface of the drain tube 30 by any desired means, such as for example, by welding, with adhesive, or with fasteners such as threaded fasteners or rivets.

The illustrated base 60 is substantially J-shaped and has a first leg 66 and a second leg 68, both extending outward of the pan 12. Two parallel mounting flanges 70 are formed at the distal end of the first leg 66, as best shown in FIGS. 1 and 3. A first circular mounting aperture 72 is formed in each of the flanges 70. Two parallel mounting flanges 74 are formed at the distal end of the second leg 68. A second circular mounting aperture 76 is formed in each of the flanges 74. The base 60 may be attached to the pan 12 by any desired means, such as for example, by welding, with adhesive, or with fasteners such as threaded fasteners or rivets.

The second handle portion 62 has an elongated body 78 with a first end 80 and a second end 82. Cylindrical posts 84 extend outwardly from opposite sides of the first end 80 and are mounted in the mounting apertures 72 of the base 60. Cylindrical posts 86 extend outwardly from opposite sides of the second end 82 of the second handle portion 62. The second end 82 of the second handle portion 62 is disposed between the attachment members 38. The posts 86 are mounted within the elongated slots 50 in the attachment members 38.

The grip 64 is attached to the first end 80 of the second handle portion 62 by any suitable means, or may be integrally formed with the second handle portion 62.

Referring again to FIG. 1, the popcorn popper 10 also includes a lid 88. The illustrated lid 88 includes a handle 90 attached to the lid 88 by fasteners 92. The fasteners 92 may be any desired type of fastener suitable for attaching the handle 90 to the lid 88. Non-exclusive examples of suitable fasteners include threaded fasteners and rivets. The handle 90 may also be attached to the lid 88 by welding or with adhesive. The lid 88 may also be provided with a handle that is removably mounted to the lid 88, or may have no handle. In the embodiment illustrated, the lid 88 includes a gas port 94 for the venting of gas or vapor, such as steam, created during the process of popping corn. Alternatively, the lid 88 may have other configurations, such as for example, being substantially perforated to facilitate constant venting. If desired, the lid 88 may also include an airtight or watertight seal.

The lid may be formed from any desired material. Non-exclusive examples of suitable material include aluminum, stainless steel, transparent material, such as glass or transparent polymers, and other heat-resistant materials.

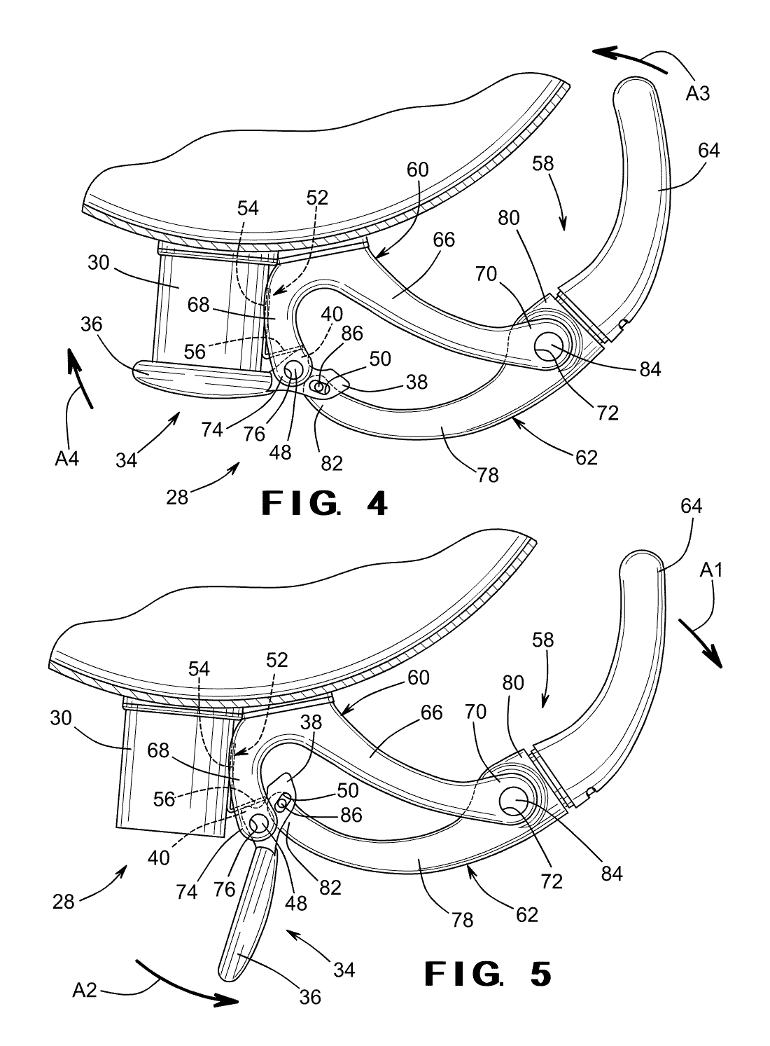

The closure 34 may be moved between a closed position as shown in FIGS. 1, 3 and 4 and an opened position as shown in FIG. 5. In the closed position, the second leg 56 of the spring 52 exerts a spring force on the cams 40 of the attachment members 38, thus urging the closure 34 in a clockwise direction when viewing FIG. 4, and into the closed position. In the opened position, the second leg 56 of the spring 52 also exerts a spring force on the cams 40 of the attachment members 38, but urges the closure 34 in a counter-clockwise direction when viewing FIG. 5, and into the opened position.

The closure 34 may be moved between a closed position as shown in FIG. 4 and the opened position as shown in FIG. 5 by movement of the grip 64 in the direction of the arrow A1. When the grip 64 is moved in the direction of the arrow A1, the first end 80 of the second handle portion 62 pivots about the posts 84. The second end 82 then moves toward the pan 12 and the posts 86 move within the slots 50 and urge the attachment members 38 to pivot within the apertures 76 and in the direction of the arrow A2, thus causing the cap 36 to move away from the drain tube 30 and to the opened position.

Likewise, the closure 34 may be moved between the opened position shown in FIG. 5 and the closed position shown in FIG. 4 by moving the grip 64 toward the pan 12 in the direction of the arrow A3. When the grip 64 is moved in the direction of the arrow A3, the first end 80 of the second handle portion 62 pivots about the posts 84. The second end 82 then moves away from the pan 12 and the posts 86 move within the slots 50 and urge the attachment members 38 to pivot within the apertures 76 and in the direction of the arrow A4, thus causing the cap 36 to move toward the drain tube 30 and to the closed position.

In operation, a user of the popcorn popper 10 may place any desired amount of popcorn kernels, cooking oil, and/or other fluid, such as flavoring fluid in the pan 12. Non-limiting examples of suitable cooking oils include olive oil, palm oil, soybean oil, canola oil, pumpkin seed oil, corn oil, sunflower oil, safflower oil, peanut oil, grape seed oil, sesame oil, other vegetable oils, coconut oil, palm oil, and animal-based oils such as butter and lard. The popcorn popper 10 may then be placed on a source of heat, such as a stove burner, and heated until the popcorn kernels reach a popping temperature, and at least one kernel of the popcorn begins to pop.

The user may then remove the popcorn popper 10 from the source of heat, move the closure 34 to the opened position, and tip the pan 12 such that the cooking oil or other fluid in the pan 12 flows out of the drain tube 30. Alternatively, if the pan 12 is not provided with a closure, the cooking oil or other fluid in the pan 12 may be poured from the pan 12 upon tipping.

The fluid in the pan 12 may be collected in a container, such as any of the containers 150, 154, and 158. Optionally, the user may attach the drain tube 30 to an attachment member of a container, such as the attachment members 156 and 164, prior to pouring the cooking oil or other fluid from the pan 12. Once the cooking oil or other fluid has been poured from the pan 12, the pan 12 may be returned to the source of heat so that the popcorn kernels may continue to pop without the excess cooking oil or other fluid in the pan 12. Because the cooking oil or other fluid has been removed from the pan 12, the freshly popped popcorn in the lower portions of the pan cannot become undesirably wet with the now removed cooking oil or other fluid. Advantageously, the cooking oil or other fluid removed from the pan 12 and collected in a container may be reused.

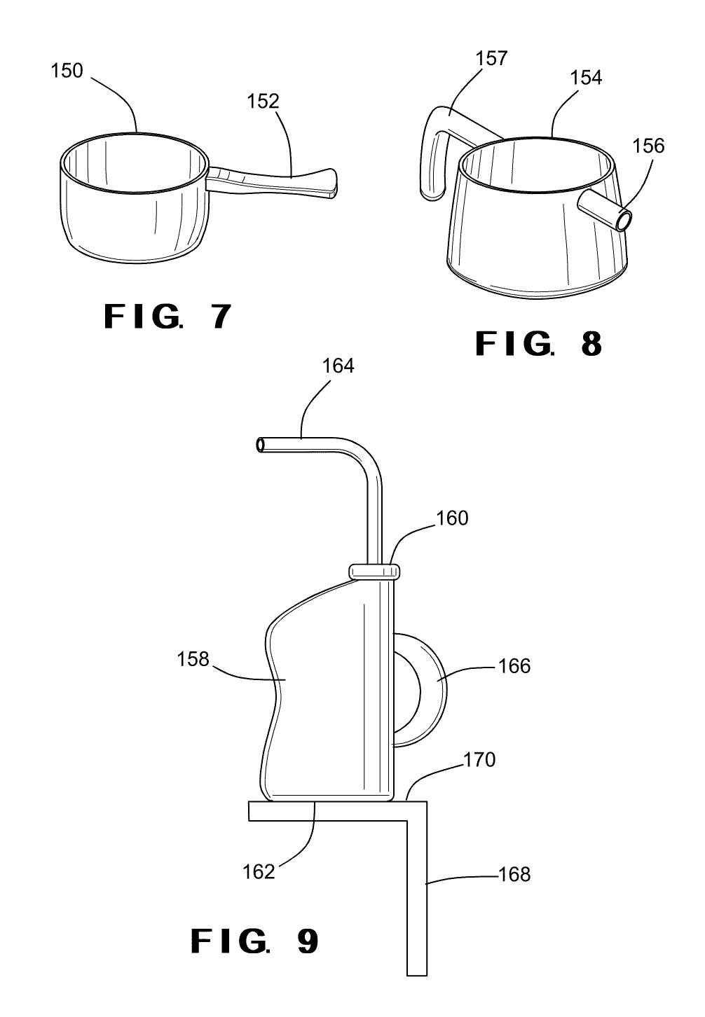

The fluid from the pan 12 may be poured into any desired container. A first embodiment of such container is an open container or cup 150, as shown in FIG. 7. The illustrated cup 150 has a handle 152, although a handle is not required. A second embodiment of a container for collecting fluid from the pan 12 is shown in FIG. 8 and includes a bowl 154 having an attachment member 156 configured for mechanical attachment to the drain tube 30. Alternatively, the attachment member 156 may be held in place by a user. The bowl 154 may also include a handle 157, although a handle is not required. A third embodiment of a container for collecting fluid from the pan 12 is shown in FIG. 9 and includes a container or bottle 158 having an opening 160 and a bottom surface 162. An attachment member 164 configured for attachment to the drain tube 30 is fluidly connected to the opening 160. The attachment member 164 may have any desired shape and may be formed from any desired rigid or flexible material. If desired, the bottle 158 may also include a handle 166, although a handle is not required.

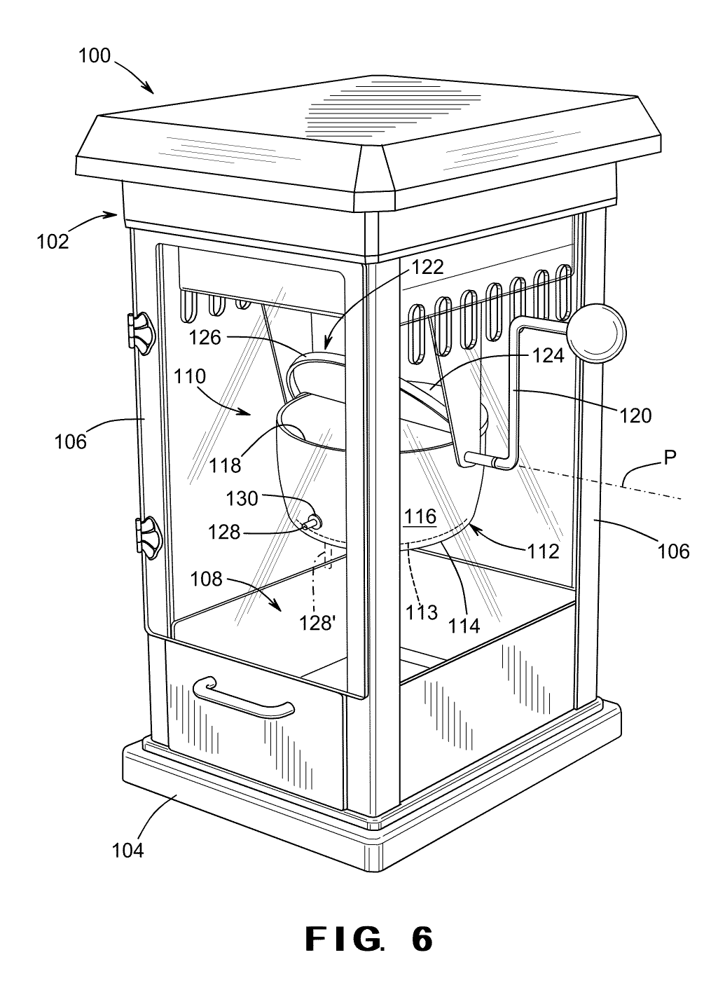

Referring now to FIG. 6, a second embodiment of a cooking apparatus is shown at 110. The exemplary cooking apparatus shown in FIG. 6 is a popcorn popper 110 and is illustrated in a typical commercial popcorn popping machine 100 that includes a case 102 having a base 104, outside walls 106 and defining a bin 108 for collecting popped corn.

The illustrated popcorn popper 110 includes a pot or pan 112 having a bottom wall 114 and an annular sidewall 116 defining a circular pan opening 118. A source of heat may be incorporated in the pan 112, but is not shown in FIG. 6. For example, a heating element (not shown) may be provided in a space between a bottom internal wall 113 and the bottom wall 114.

A drain tube 128 is attached to the sidewall 116 of the pan 112 about a drain port (not shown) formed through the sidewall 116. The drain port may be a single hole, or a plurality of holes, such as the holes 22 shown in FIG. 2. As described above, the drain port is configured to allow the flow of fluid from inside the pan 112, through the drain tube 128, to a location outside the pan 112.

The illustrated drain tube 128 is cylindrical and attached to the sidewall 116 via a collar 130. The collar 130 and the drain tube 128 may be attached to the sidewall 116 by any desired means, such as described above in detail. The pan 112 may also be formed with the drain ports 182, 190, and 196, as shown in FIGS. 10, 11, and 12, respectively.

The drain tube 128 may have any other shape suitable for the discharge of fluid from within the pan 112. The drain tube 128 may also be positioned at any desired location on the sidewall 116 in order to facilitate the discharge of fluid from within the pan 112.

Alternatively, the drain tube may extend from the bottom internal wall 113, through the space, and outwardly of the bottom wall 114, as shown at 128′ in FIG. 6. Like the drain tube 128, the drain tube 128′ may have any shape suitable for the discharge of fluid from within the pan 112, and may extend outwardly from any location of the bottom wall in order to facilitate the discharge of fluid from within the pan 112.

Although not shown in FIG. 6, the drain tubes 128 and 128′ may have a closure, such as any of the closures described above for use on the first embodiment of the popcorn popper 10. Additionally, the downwardly extending drain tube 128′ may also have any type of valve that may be selectively moved between open and closed positions so as to allow a user to drain fluid through the drain tube 128′ without having to tip the pan 112. It will be understood that the pan 112 may also have both the drain tube 128 and the drain tube 128′.

The illustrated pan 112 is pivotally mounted to the case 100 about a pivot axis P. A tilt arm 120 is connected to the pan 112 at the pivot axis P and is operative to pivot the pan 112 about the pivot axis P.

A lid 122 for closing the pan 112 during the popping process is mounted about the pan opening 118. The illustrated lid 122 is formed in two parts and includes a first or rear portion 124 attached to the pan opening 118. A second or forward portion 126 is hingedly attached to the first portion 124. The hinged connection allows the forward portion 126 to fall open with the popcorn popper 110 is tipped forward.

In operation, a user of the popcorn popper 110 may place any desired amount of popcorn kernels, cooking oil, and/or other fluid, such as flavoring fluid in the pan 112. Heat from the source of heat (not shown) may then be applied to the pan 112 until the popcorn kernels reach a popping temperature, and at least one kernel of the popcorn begins to pop. The user may remove a closure from the drain tube 128, then grasp the tilt arm 120 and tip the pan 112 about the pivot axis P such that the fluid in the pan 112 flows out of the drain tube 128. Alternatively, if the pan 112 is not provided with a closure, the cooking oil or other fluid in the pan 112 may be poured from the pan 112 upon tipping.

The fluid in the pan 112 may be collected in a container, such as any of the containers 150, 154, and 158. Optionally, the user may attach the drain tube 128 to an attachment member of a container, such as the attachment members 156 and 164, prior to pouring the cooking oil or other fluid from the pan 112. Once the cooking oil or other fluid has been poured from the pan 112, heat may be reapplied to the pan 112 so that the popcorn kernels may continue to pop without the excess cooking oil or other fluid in the pan 12. Because the cooking oil or other fluid has been removed from the pan 112, the freshly popped popcorn in the lower portions of the pan 112 cannot become undesirably wet with the now removed cooking oil or other fluid. Advantageously, the cooking oil or other fluid removed from the pan 112 and collected in a container may be reused.

A mounting member 168 may be provided and include a mounting surface 170, as shown in FIG. 9. The mounting member 168 may be attached to an object, such as the wall 106 of the popcorn popping machine 100, shown in FIG. 6. The bottle 158 may be attached to the mounting member 168 or the bottom surface 162 of the bottle 158 may rest upon the mounting surface 170. It will be understood that the mounting member 168 may be attached at any desired location on the inside or the outside of the popcorn popping machine 100.

A container, such as the bottle 158 may be positioned on the mounting member 168 such that the attachment member 164 may be connected to the drain tube 128 when the pan 112 is tipped about the pivot axis P. Fluid may then flow from inside the pan 112, through the drain tube 128, to the bottle 158. Upon discharge of the fluid into the bottle 158, the attachment member 164 may be disconnected from the drain tube 128 and the pan 112 returned to its original, un-tipped position.

The principle and mode of operation of the cooking apparatus have been described in its preferred embodiments. However, it should be noted that the cooking apparatus described herein may be practiced otherwise than as specifically illustrated and described without departing from its scope.

What is claimed is:

1. A method of popping popcorn comprising:
combining unpopped popcorn kernels and cooking oil in a pan configured to contain popcorn kernels to be popped;
heating the pan with a source of heat until the popcorn kernels reach a popping temperature and begin to pop;
pouring at least a portion of the cooking oil from the pan through a drain port formed in the pan, the drain port configured for the transmission of fluid between an inside of the pan and an outside of the pan.

2. The method according to claim 1, further including pouring the portion of the cooking oil into a container configured to receive and hold fluid poured from the pan through the drain port.

3. The method according to claim 1, further including the step of separating the pan from the source of heat prior to pouring the portion of the cooking oil from the pan.

4. The method according to claim 1, wherein the drain port comprises one of a hole formed in the pan and a drain tube attached to the pan and defining a fluid flow path.

5. The method according to claim 4, wherein prior to pouring the portion of the cooking oil from the pan, moving a drain tube closure between an opened position wherein the flow of fluid through the drain tube is permitted, and a closed position wherein the flow of fluid through the drain tube is prevented.

6. The method according to claim 5, further including operating an actuator that is operative to move the drain tube closure between the open and closed positions prior to pouring the portion of the cooking oil from the pan.

7. The method according to claim 5, further including pouring the portion of the cooking oil from the pan into a container configured to receive and hold fluid.

8. The method according to claim 7, further including attaching the drain tube to an attachment member of the container, wherein the attachment member is configured for attachment to the drain tube and defines a fluid flow path between the drain tube and the container.

9. A method of popping popcorn comprising:
combining unpopped popcorn kernels and cooking oil in a pan mounted within a commercial popcorn popping machine case and configured to contain popcorn kernels to be popped;
heating the pan with a source of heat until the popcorn kernels reach a popping temperature and begin to pop;
pouring at least a portion of the cooking oil from the pan through a drain port formed in a wall of the pan, the drain port configured for the transmission of fluid between an inside of the pan and an outside of the pan.

10. The method according to claim 9, further including pouring the portion of the cooking oil into a container configured to receive and hold fluid poured from the pan through the drain port.

11. The method according to claim 10, wherein the container is mounted to the commercial popcorn popping machine case.

12. The method according to claim 9, further including the step of separating the pan from the source of heat prior to pouring the portion of the cooking oil from the pan.

13. The method according to claim 9, wherein the drain port comprises one of a hole formed in the pan and a drain tube attached to the pan and defining a fluid flow path.

14. The method according to claim 13, wherein prior to pouring the portion of the cooking oil from the pan, moving a drain tube closure between an opened position wherein the flow of fluid through the drain tube is permitted, and a closed position wherein the flow of fluid through the drain tube is prevented.

15. The method according to claim 14, further including operating an actuator that is operative to move the drain tube closure between the open and closed positions prior to pouring the portion of the cooking oil from the pan.

16. The method according to claim 14, further including pouring the portion of the cooking oil from the pan into a container configured to receive and hold fluid.

17. The method according to claim 16, further including attaching the drain tube to an attachment member of the container, wherein the attachment member is configured for attachment to the drain tube and defines a fluid flow path between the drain tube and the container.

18. The method according to claim 16, wherein the container is mounted to the commercial popcorn popping machine case

19. A popcorn popper comprising:
a pan configured to contain popcorn kernels to be popped; and
a drain port formed in a wall of the pan, the drain port configured for the transmission of fluid between an inside of the pan and an outside of the pan.

20. The popcorn popper according to claim 19, wherein the drain port includes a drain tube attached to the wall of the pan and defining a fluid flow path, and wherein the popcorn popper further includes a container configured to receive and hold fluid poured from the pan through the drain tube.
